(19) United States
(12) Patent Application Publication
(10) Pub. No.: US 2012/0162043 A1
(43) Pub. Date: Jun. 28, 2012

(54) MULTIBAND ANTENNA

(75) Inventor: YI-CHIEH LEE, Tu-Cheng (TW)

(73) Assignee: CHI MEI COMMUNICATION SYSTEMS, INC., Tu-Cheng (TW)

(21) Appl. No.: 13/038,481

(22) Filed: Mar. 2, 2011

(30) Foreign Application Priority Data
Dec. 28, 2010 (TW) 99146448

(51) Int. Cl. H01Q 5/01; H01Q 7/00

(52) U.S. Cl. 343/870; 343/866

(57) ABSTRACT

A multiband antenna includes a feed unit, a first transceiving unit, a second transceiving unit, and a resonance unit. The first transceiving unit and the second transceiving unit cooperatively form a loop. When feed signals are input to the feed unit, the feed signals are respectively transmitted through the first transceiving unit and the second transceiving unit to enable the first transceiving unit and the second transceiving unit to respectively receive and send wireless signals of different frequencies, and the resonance unit is driven to resonate and cooperate with the first transceiving unit and the second transceiving unit to respectively form additional antenna members, such that the multiband antenna is capable of receiving and sending wireless signals in more than two frequency bands.

### BACKGROUND 1. Technical Field

The present disclosure relates to multiband communication technology, and particularly to a multiband antenna for portable electronic devices.

2. Description of Related Art

Portable electronic devices, such as mobile phones, personal digital assistants (PDA), and laptop computers, often utilize mounted antennas for receiving/sending wireless signals. Commonly, a portable electronic device may receive/send wireless signals of different frequencies, requiring the presence of a multiband antenna.

However, multiband antennas tend to be large with complicated structure, compromising efforts toward minimization of portable electronic device size. Even where installation of miniaturized multiband antennas within such portable electronic devices is possible, communication capabilities of miniaturized multiband antennas may be adversely affected due to their limited size. For example, many multiband antennas used in portable electronic devices are unable to receive/send wireless signals in more than two frequency bands. Additionally, multiband antennas often generate more electromagnetic radiation than single-band. Portable electronic devices employing multiband antennas may have high electromagnetic wave specific absorption rates (SAR).

Therefore, there is room for improvement within the art.

### BRIEF DESCRIPTION OF THE DRAWINGS

Many aspects of the present multiband antenna can be better understood with reference to the following drawings. The components in the various drawings are not necessarily drawn to scale, the emphasis instead being placed upon clearly illustrating the principles of the present multiband antenna. Moreover, in the drawings, like reference numerals designate corresponding parts throughout the figures.

FIG. 1 is a schematic view of a multiband antenna, according to a first exemplary embodiment.

FIG. 2 is a schematic view of the multiband antenna shown in FIG. 1, viewed from another angle.

FIG. 3 is a diagram showing RL (return loss) measurement of the multiband antenna shown in FIG. 1.

FIG. 4 is a schematic view of a multiband antenna, according to a second exemplary embodiment.

### DETAILED DESCRIPTION

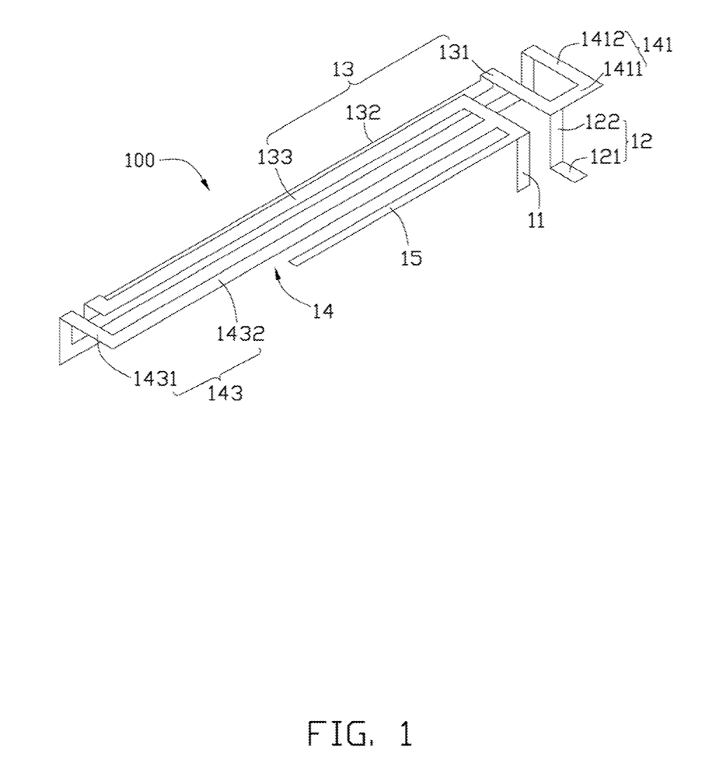

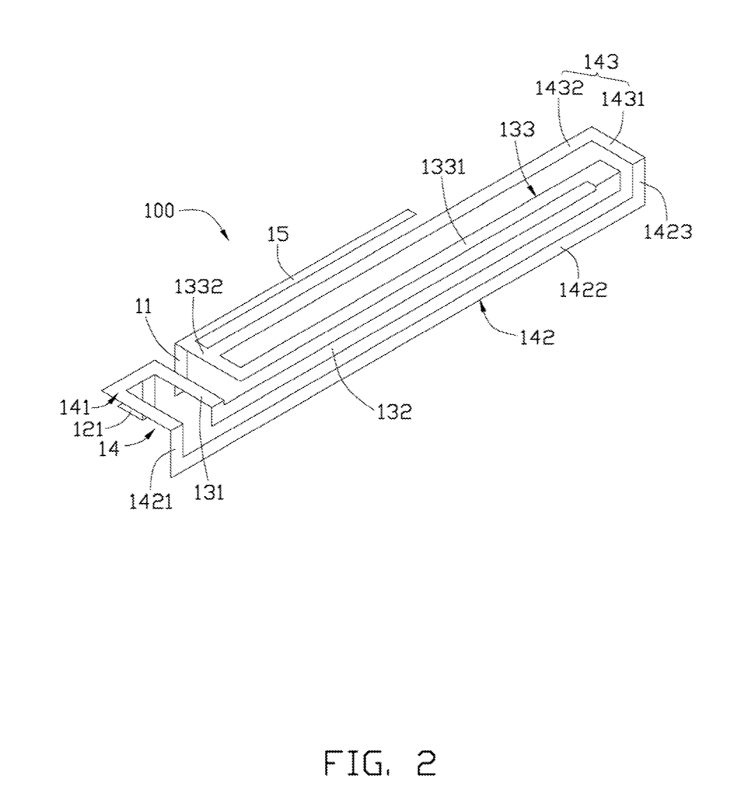

FIG. 1 and FIG. 2 schematically show a multiband antenna 100, according to an exemplary embodiment. The multiband antenna 100 consists of conductive sheets, such that size and profile thereof are minimized, meeting suitability for use in a portable electronic device such as a mobile phone, a personal digital assistant (PDA), or a laptop computer. The conductive sheets can be made of metal, flexible printed circuits (FPC), or other materials. The multiband antenna 100 includes a feed unit 11, a grounded unit 12, a first transceiving unit 13, a second transceiving unit 14, and a first resonance unit 15.

The feed unit 11 is a longitudinal planar sheet. The grounded unit 12 includes a grounded portion 121 and a connecting portion 122, which are both longitudinal planar sheets. The connecting portion 122 is positioned coplanar with and parallel to the feed unit 11. The grounded portion 121 is positioned in a plane that is perpendicular to the plane in which the feed unit 11 and the connecting portion 122 are positioned, and is connected to one end of the connecting portion 122.

The first transceiving unit 13 includes a first transceiving portion 131, a second transceiving portion 132, and a third transceiving portion 133. The first transceiving portion 131 is a longitudinal planar sheet positioned in a plane that is parallel to the plane in which the grounded portion 121 is positioned. One end of the first transceiving portion 131 is connected to another end of the connecting portion 122. The second transceiving portion 132 is a longitudinal planar sheet positioned in a plane that is parallel to the plane in which the feed unit 11 and the connecting portion 122 are positioned. Another end of the first transceiving portion 131 is connected to one end of a side of the second transceiving portion 132.

The third transceiving portion 133 is an L-shaped planar sheet positioned coplanar with the first transceiving portion 131 and connected to the same side of the second transceiving portion 132 as the first transceiving portion 131. The third transceiving portion 133 includes first connecting section 1331 and a first feed section 1332, which are both longitudinal planar sheets and are connected perpendicular to each other. The first connecting section 1331 extends towards and is perpendicular to the first transceiving portion 131. A side of one end of the first connecting section 1331 is connected to another end of the side of the second transceiving portion 132 connected to the first transceiving portion 131. Another end of the first connecting section 1331 is connected perpendicular to one end of the feed section 1332. The first feed section 1332 is positioned parallel to the first transceiving portion 131. Another end of the first feed section 1332 is connected to the feed unit 11.

The second transceiving unit 14 includes a fourth transceiving portion 141, a fifth transceiving portion 142, and a sixth transceiving portion 143. The fourth transceiving portion 141 is an L-shaped planar sheet positioned coplanar with the first transceiving portion 131 and the third transceiving portion 133, and the fourth transceiving portion 141 and the third transceiving portion 133 are respectively positioned at two opposite sides of the first transceiving portion 131. The fourth transceiving portion 141 includes a second feed section 1411 and a second connecting section 1412, which are both longitudinal planar sheets and are connected perpendicular to each other. One end of the second feed section 1411 is connected perpendicular to the side of the first transceiving portion 131 opposite to the third transceiving portion 133, and is positioned adjacent to the connecting portion 122. Another end of the second feed section 1411 is connected perpendicular to an end of the second connecting section 1412. The second connecting section 1412 is positioned parallel to the first transceiving portion 131.

The fifth transceiving portion 142 is an approximately U-shaped planar sheet positioned coplanar with the second transceiving portion 132. The fifth transceiving section 142 includes a main section 1422 and two arm sections 1421, 1423, which are all longitudinal. The two arm sections 1421, 1423 are respectively connected perpendicular to two ends of the same side of the main section 1422. A distal end of the arm section 1421 is connected perpendicular to another end of the second connecting section 1412. The main section 1422 is positioned parallel to the second transceiving portion 132.

The sixth transceiving portion 143 is an L-shaped planar sheet positioned coplanar with the first transceiving portion 131, the third transceiving portion 133, and the fourth transceiving portion 141. The sixth transceiving portion 143 includes a third connecting section 1431 and a fourth connecting section 1432, which are both longitudinal planar sheets and are connected perpendicular to each other. The third connecting section 1431 is positioned parallel to the first feed section 1332. One end of the third connecting section 1431 is connected to a distal end of the arm section 1423, and the other end of the third connecting section 1431 is connected perpendicular to one end of the fourth connecting section 1432. The fourth connecting section 1432 is positioned parallel to the first connecting section 1331. Another end of the fourth connecting section 1432 is connected perpendicular to a middle part of the first feed portion 1332. Thus, the first transceiving unit 13 and the second transceiving unit 14 cooperate with each other to form a loop (not labeled).

The first resonance unit 15 is a longitudinal planar sheet that is positioned coplanar with the first transceiving portion 131, the third transceiving portion 133, the fourth transceiving portion 141, and the sixth transceiving portion 143. An end of the first resonance unit 15 is connected perpendicular to the same side of the first feed portion 1332 as the first connecting section 1331 and the fourth connecting section 1432, and is positioned proximate to the end of the first feed portion 1332 connected to the feed unit 11. The first resonance unit 15 is positioned parallel to the first connecting section 1331 and the fourth connecting section 1432, and is configured to be shorter than both the first connecting section 1331 and the fourth connecting section 1432.

When the multiband antenna 100 is used, the grounded unit 12 is attached to a circuit board (not shown) of the portable electronic device to be grounded, and the feed unit 11 is connected to the circuit board to receive feed signals. Feed signals input from the feed unit 11 can be respectively transmitted to the grounded unit 12 through the first transceiving unit 13 and the second transceiving unit 14, thereby forming two current paths of different lengths. Thus, the first transceiving unit 13 and the second transceiving unit 14 are respectively enabled to serve as antenna members for receiving and sending wireless signals of different frequencies. Furthermore, the loop formed by the first transceiving unit 13 and the second transceiving unit 14 can serve as a loop antenna member for receiving and sending wireless signals of additional frequencies. Simultaneously, the first resonance unit 15 is resonated by the current through the first transceiving unit 13 and the second transceiving unit 14, and thereby enabled to serve as an additional antenna member. The resonance unit 15 can further cooperate with the first transceiving unit 13 and the second transceiving unit 14 to form additional antenna members, respectively. In this way, the multiband antenna 100 can be used to receive and send wireless signals in a plurality of different frequency bands.

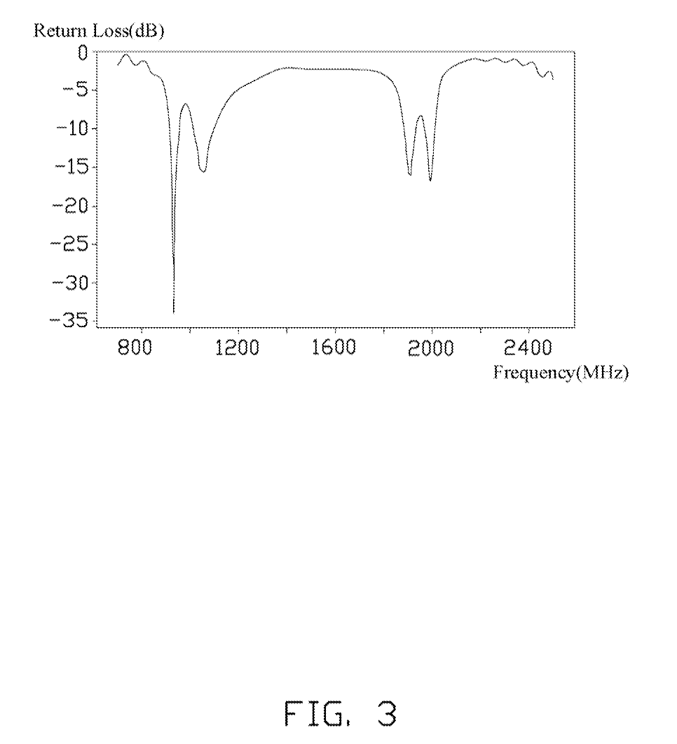

Referring to FIG. 3, as shown in experiments, the return loss (RL) of the multiband antenna 100 is acceptable when the multiband antenna 100 receives/sends wireless signals in many frequency bands. Particularly, the RL of the multiband antenna 100 is less than −5 dB when the multiband antenna 100 receives/sends wireless signals of frequencies of about 900 MHz, 1050 MHz, 1900 MHz, and 2000 MHz. Accordingly, the electronic device employing the multiband antenna 100 can be used in a plurality of (more than two) common wireless communication systems, such as GSM900, DCS1800, PCS1900, UMTS2100, etc., with acceptable communication quality.

Also referring to the tabulation, as shown in experiments, when the multiband antenna 100 receives/sends wireless signals of frequencies of about 900 MHz and 1050 MHz, efficiency and SAR of the multiband antenna 100 are both acceptable. Compared with a conventional antenna, the multiband antenna 100 has a similar efficiency and a lower SAR in the working frequency of about 900 MHz, and has a higher efficiency and a lower SAR in the working frequency of about 1050 MHz.

| | Efficiency (%) | | SAR(W/kg) | |
|---|---|---|---|---|
| Antenna types | 930 MHz | 1050 MHz | 930 MHz | 1050 MHz |
| Common multiband | 42% | 42% | 1.32 | 1.32 |
| antenna | | | | |
| Present multiband antenna | 40% | 58% | 0.99 | 0.73 |

Due to the composition disclosed, in assembly, the multiband antenna 100 can be supported and protected on a cubic substrate (not shown). Particularly, the first transceiving portion 131, the third transceiving portion 133, the fourth transceiving portion 141, the sixth transceiving portion 143, and the first resonance unit 15 can be attached on a top surface of the substrate. The feed unit 11 and the connecting portion 122 can be attached on a side surface of the substrate. The second transceiving portion 132 and the fifth transceiving portion 142 can be attached on another side surface of the substrate opposite to the side surface for mounting the feed unit 11 and the connecting portion 122. Thus, most parts of the multiband antenna 100 can be flatly attached on the substrate, and an outer shape of an assembly including the substrate and the multiband antenna 100 mounted thereon is also approximately cubic. Accordingly, the multiband antenna 100 is protected from damage, and assembly, installation, and transportation of the multiband antenna 100 are simplified.

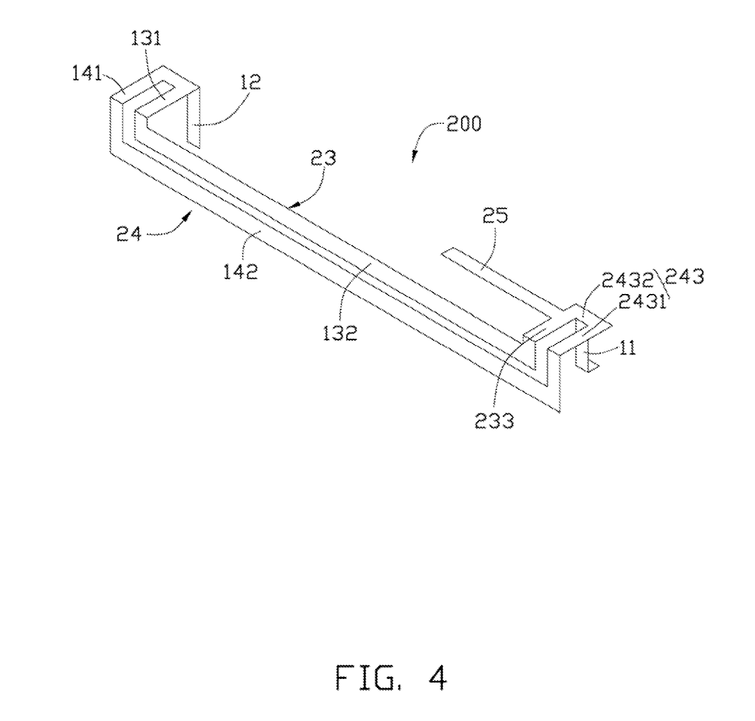

FIG. 4 shows a multiband antenna 200, according to a second exemplary embodiment. The multiband antenna 200 differs from the multiband antenna 100 only in that the first transceiving unit 13, the second transceiving unit 14, and the first resonance unit 15 are respectively replaced by a third transceiving unit 23, a fourth transceiving unit 24, and a second resonance unit 25.

The third transceiving unit 23 and the fourth transceiving unit 24 respectively differ from the first transceiving unit 13 and the second transceiving unit 14 only in that a seventh transceiving portion 233 and an eighth transceiving portion 243 replace the third transceiving portion 133 and the sixth transceiving portion 233 correspondingly, and thus the third transceiving unit 23 and the fourth transceiving unit 24 cooperatively form a loop (not shown) smaller than that formed by the first transceiving unit 13 and the second transceiving unit 14. The seventh transceiving portion 233 and the eighth transceiving portion 243 respectively differ from the third transceiving portion 133 and the sixth transceiving portion 143 only in shape and size.

The seventh transceiving portion 233 is a longitudinal planar sheet positioned coplanar with and parallel to the first transceiving portion 131 and the fourth transceiving portion 141. One end of the seventh transceiving portion 233 is connected to an end of a side of the second transceiving portion 132, and the other is connected to the feed unit 11. The eighth transceiving portion 243 is an L-shaped planar sheet positioned coplanar with the first transceiving portion 131, the fourth transceiving portion 141, and the seventh transceiving portion 233. The eighth transceiving portion 243 includes a fifth connecting section 2431 and a sixth connecting section 2432, which are both longitudinal planar sheets. The fifth connecting section 2431 is similar to the third connecting section 1431. Two ends of the sixth connecting section 2432 are respectively connected to the fifth connecting section 2431 and the seventh transceiving portion 233. Thus, the third transceiving unit 23 and the fourth transceiving unit 24 cooperatively form the loop. The seventh transceiving portion 233 and the sixth connecting section 2432 are respectively shorter than the third transceiving portion 133 and the fourth connecting section 1432, therefore, the loop formed by the third transceiving unit 23 and the fourth transceiving unit 24 is less than the loop formed by the first transceiving unit 13 and the second transceiving unit 14.

The second resonance unit 25 is a longitudinal planar sheet that is positioned coplanar with the first transceiving portion 131, the fourth transceiving portion 141, the seventh transceiving portion 233, and the eighth transceiving portion 243. An end of the second resonance unit 15 is connected perpendicular to a side of the seventh transceiving portion 233 opposite to the side of the seventh transceiving portion 233 connected to the sixth connecting section 2432, and the second resonance unit 15 extends towards the first transceiving portion 131. The second resonance unit 15 is configured to be shorter than both the second transceiving portion 132 and the fifth transceiving portion 142.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A multiband antenna, comprising:
a feed unit;
a first transceiving unit connected to the feed unit;
a second transceiving unit connected to the first transceiving unit, the first transceiving unit and the second transceiving unit cooperatively form a loop; and
a resonance unit connected to the first transceiving unit; wherein when feed signals are input to the feed unit, the feed signals are respectively transmitted through the first transceiving unit and the second transceiving unit to enable the first transceiving unit and the second transceiving unit to respectively receive and send wireless signals of different frequencies, and the resonance unit is driven to resonate and cooperate with the first transceiving unit and the second transceiving unit to respectively form additional antenna members, such that the multiband antenna is capable of receiving and sending wireless signals in more than two frequency bands.

2. The multiband antenna as claimed in claim 1, further comprising a grounded unit connected to the first transceiving unit, wherein the feed signals input to the feed unit are respectively transmitted to the grounded unit through the first transceiving unit and the second transceiving unit.

3. The multiband antenna as claimed in claim 2, wherein the first transceiving unit includes a first transceiving portion, a second transceiving portion, and a third transceiving portion, which are all planar sheets; the first transceiving portion and the third transceiving portion positioned coplanar with each other, and the second transceiving portion positioned in a plane perpendicular to the plane in which the first transceiving portion and the third transceiving portion are positioned.

4. The multiband antenna as claimed in claim 3, wherein the first transceiving portion and the second transceiving portion are both longitudinal, the first transceiving portion having one end connected to the grounded unit and another end connected to one end of a side of the second transceiving portion.

5. The multiband antenna as claimed in claim 4, wherein the third transceiving portion includes a first connecting section and a first feed section, which are both longitudinal and are connected perpendicular to each other; the first connecting section extending towards the first transceiving portion and positioned perpendicular to the first transceiving portion, a side of one end of the first connecting section connected to another end of the side of the second transceiving portion connected to the first transceiving portion; another end of the first connecting section connected perpendicular to one end of the feed section; another end of the first feed section connected to the feed unit.

6. The multiband antenna as claimed in claim 5, wherein the second transceiving unit includes a fourth transceiving portion, a fifth transceiving portion, and a sixth transceiving portion, which are all planar sheets; the fourth transceiving portion and the sixth transceiving portion positioned coplanar with the first transceiving portion and the third transceiving portion, and the fifth transceiving portion positioned coplanar with the second transceiving portion.

7. The multiband antenna as claimed in claim 6, wherein the fourth transceiving portion includes a second feed section and a second connecting section, which are both and are connected perpendicular to each other; one end of the second feed section connected perpendicular to a side of the first transceiving portion opposite to the third transceiving portion and positioned adjacent to the grounded unit, and another end of the second feed section connected to an end of the second connecting section; the second connecting section positioned parallel to the first transceiving portion.

8. The multiband antenna as claimed in claim 7, wherein the fifth transceiving portion includes a longitudinal main section and two arm sections, which are all longitudinal; the two arm sections respectively connected perpendicular to two ends of the same side of the main section, a distal end of one arm section connected perpendicular to another end of the second connecting section; the main section positioned parallel to the second transceiving portion.

9. The multiband antenna as claimed in claim 8, wherein the sixth transceiving portion includes a third connecting section and a fourth connecting section, which are both longitudinal and are connected perpendicular to each other; the third connecting section positioned parallel to the first feed section, one end of the third connecting section connected to a distal end of another arm section, and another end of the third connecting section connected to one end of the fourth connecting section; the fourth connecting section positioned parallel to the first connecting section, and another end of the fourth connecting section connected perpendicular to the first feed portion.

10. The multiband antenna as claimed in claim 9, wherein the feed unit is a planar sheet positioned in a plane that is parallel to the plane in which the second transceiving portion and the fifth transceiving portion are positioned.

11. The multiband as claimed in claim 10, wherein the resonance unit is a longitudinal planar sheet positioned coplanar with the first transceiving portion, the third transceiving portion, the fourth transceiving portion, and the sixth transceiving portion, and parallel to the first connecting section and the fourth connecting section; an end of the resonance unit connected to the same side of the first feed portion as the first connecting section and the fourth connecting section, and positioned proximate to the end of the first feed portion connected to the feed unit.

12. The multiband antenna as claimed in claim 10, wherein the grounded unit includes a grounded portion and a connecting portion, which are both planar sheets; the connecting portion connected to both the first transceiving portion and the grounded portion, and positioned coplanar with the feed unit.

13. The multiband antenna as claimed in claim 3, wherein the third transceiving portion is longitudinal, one end of the third transceiving portion connected to another end of the side of the second transceiving portion connected to the first transceiving portion, and the other connected to the feed unit.

14. The multiband antenna as claimed in claim 13, wherein the second transceiving unit includes a fourth transceiving portion, a fifth transceiving portion, and a sixth transceiving portion, which are all planar sheets; the fourth transceiving portion and the sixth transceiving portion positioned coplanar with the first transceiving portion and the third transceiving portion, and the fifth transceiving portion positioned coplanar with the second transceiving portion.

15. The multiband antenna as claimed in claim 14, wherein the sixth transceiving portion includes a fifth connecting section and a sixth connecting section, which are both longitudinal; two ends of the sixth connecting section respectively connected to the fifth connecting section and the third transceiving portion.

16. The multiband antenna as claimed in claim 15, wherein the resonance unit is a longitudinal planar sheet positioned coplanar with the first transceiving portion, the third transceiving portion, the fourth transceiving portion, and the sixth transceiving portion;
an end of the resonance unit connected perpendicular to a side of the third transceiving portion opposite to the side of the third transceiving portion connected to the sixth connecting section, and the resonance unit extending towards the first transceiving portion.

17. The multiband antenna as claimed in claim 1, wherein the first resonance unit serves as an additional antenna member.

18. The multiband antenna as claimed in claim 1, wherein the loop formed by the first transceiving unit and the second transceiving unit serves as an additional loop antenna member.
